(19) United States
(12) Patent Application Publication
(10) Pub. No.: US 2010/0311018 A1
(43) Pub. Date: Dec. 9, 2010

(54) Method and Apparatus for Teaching Aspects of Finance to a Young Child

(76) Inventor: Jason Grant Magers, Scottsdale, AZ (US)

Correspondence Address: Woods Oviatt Gilman LLP, 700 Crossroads Bldg, 2 State St., Rochester, NY, 14614, US

(21) Appl. No.: 12/795,023

(22) Filed: Jun. 7, 2010

Related U.S. Application Data
(60) Provisional application No. 61/184,372, filed on Jun. 5, 2009.

(51) Int. Cl. G09B 19/18

(52) U.S. Cl. 434/107

(57) ABSTRACT

An apparatus and method is provided for teaching fundamentals of finance to a young child. Using colorful currency cards, the young child is taught such principles as cash-flow, savings, investing and banking by a hands-on participation in ongoing, life-like financial events.

### CROSS REFERENCE TO RELATED APPLICATIONS

This application claims the benefit of U.S. Provisional Application No. 61/184,372, filed Jun. 5, 2009.

### TECHNICAL FIELD

The present invention relates to a method and apparatus for teaching fundamentals of finance to a child; more particularly, for teaching to the child such fundamentals as cash-flow, savings, investing and banking; and most particularly, for teaching such fundamentals by the child's participation in actual, real-world economic transactions.

### BACKGROUND OF THE INVENTION

In the changing economic world, there is a need to reach children at a very young age regarding fiscal responsibility. Typically, a young child is first introduced to financial concepts in a family setting through an allowance-reward system. If a child meets expected behavioral standards set by the parent, an allowance (income) of a specific monetary value is given. If a child does not meet expected standards, the income is reduced or withheld. The allowance paid to the child in the form of currency has little or no intrinsic value to the child. Therefore, the incentive for striving to receive the income (and therefore meet the expected behavioral standards) is based solely on what the child can purchase (expense) in the open market in exchange for the income received. To a younger child, it might be a fast food treat or a toy; to an older child, tickets to a concert, clothing or a CD.

To a young child between the ages of 2 to 12, an allowance in the form of currency (coin or bill), has little or no intrinsic value because the reward (the currency) is tied to our economy's open market. Using, as an example, a desired toy having a purchase price of $25.00, an allowance suitable for a young child is likely not enough for the child to make an immediate purchase of the desired toy. Moreover, even if it were enough, not enough of the allowance would be left in reserve to teach the child the concept of saving, budgeting, giving to charity or investing. Having the child save a multiple of allowance installments to later make a purchase of the desired toy will likely not work as an incentive because the young child will loose interest in the purchase (and thus the incentive) before enough money is saved to make the purchase. As a result, in frustration, the child may make a spontaneous but frivolous purchase upon receipt of the allowance in order to enjoy the reward for good behavior or, if a purchase is not made, loose interest all-together in the reward-allowance system.

Thus, the typical reward-allowance system, being based on the value of our open economy, is prone to failure and, at a minimum, serves as a disincentive for making prudent purchases, and for saving, investing, budgeting and giving to charity.

In addition, to a young child, the various currency denominations used in a traditional reward-allowance system offer little intrinsic attraction to the young child, other than what the child may associate with the currency's face value. Thus, since there is little or no inherent desire on the part of the child to hold on to the currency any longer then needed to make a purchase, the lesson of saving becomes more difficult to teach to the child using open market currency.

A board game for teaching young children the principles of finance is disclosed in U.S. Pat. No. 6,106,300 issued on Aug. 22, 2000. The object of the game, as disclosed, is for the player to generate passive income greater than the player's expenses using game pieces and parameters set by the rules of the game. However, since the lessons in finance are taught in a board game setting, the events affecting passive income and expenses are limited by the game's design, are not under the control of the parent/teacher and are not designed to best relate to the particulars of the child being taught. Moreover, the lessons are taught only while the game is being played.

What is needed is a way of teaching fundamentals of finance to a child wherein the teachings are tied to parameters established and controlled internally, are designed to teach principles practical to the every-day world, such as cash-flow, savings, investing and taxation, and are not linked directly to the economy's open market.

### SUMMARY OF THE INVENTION

Briefly described, a set of cards including a multiple of colorful characters is provided as currency. A method of teaching the fundamentals of finance to a young child using the cards includes providing a central figure (referred herein as central reserve) for overseeing the parameters of teaching. Central reserve establishes the entire bounds of the economic system used to teach the fundamentals. That is, the system used for teaching is a closed system under full control of the central reserve. The young child interacts with central reserve to establish several of the economic parameters of the closed system. Central reserve sets the basic expected behavioral standards that must be met by the young child, and the number of currency cards that will be provided to the young child if the expected behavioral standards are met. Central reserve also establishes such parameters as the frequency in which currency cards will be allotted on a scheduled basis to the young child. Other parameters set by central reserve include interest rates paid on savings, return rates paid on secured investments and amounts that must be paid as fixed expenses (contributions to charity, taxes, etc).

As the young child becomes desirous of a reward item or privilege, a request is made to central reserve to purchase the privilege or item. For each approved request, central reserve sets the purchase price for the item or privilege in terms of number of currency cards. The young child may then purchase the item or privilege using the currency cards in his or her possession.

As currency cards are received by the young child, the cards are placed in a box held by the child (the bank). To encourage savings (and to discourage spontaneous or frivolous spending), a savings account portion may be established as part of the child's bank. Central reserve establishes a fixed interest rate and a fixed period for paying interest on the number of currency cards kept in the bank. Interest earned may be paid to the young child in terms of additional cards.

In another aspect of the invention, the young child may choose to place currency cards earmarked for secured investments in a box held by central reserve. In this aspect of the invention, central reserve sets the rate of return and the term in which the investments must remain invested. During the term, the young child will have no access to the held currency cards and, therefore, cannot spend the currency cards on privileges or items desired or cannot enjoy handling the cards or viewing the characters. At the end of the term, central reserve pays to the young child an amount of currency cards equal to the rate of return. At that point, the young child has the option of leaving all or a portion of the principal in the secured investments to earn more interest, or moving it entirely to his or her bank for making purchases or for keeping in his or her savings account at the fixed interest rate.

In another aspect of the invention, the young child is taught the need for providing for fixed expenses which would be the equivalent of paying taxes or contributing to charity or worship in real life. In this aspect of the invention, central reserve sets the percentage of income that must be paid as fixed expenses. Once the rate is set, the young child will be required to pay in currency cards an amount as a portion of his/her income (currency cards received).

### BRIEF DESCRIPTION OF THE DRAWINGS

The present invention will now be described, by way of example, with reference to the accompanying drawings, in which:

FIG. 1 are examples of currency cards, in accordance with the invention, showing examples of colorful characters printed on the cards; and

FIG. 2 is a flow chart showing aspects of the method of teaching, in accordance with the invention, using the currency cards shown in FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

In the prior art allowance-reward system, its drawback as a method of teaching the fundamentals of finance to a young child is that the system is based on the value of our open market economy which is often irrelevant to the child. In the board game disclosed in U.S. Pat. No. 6,106,300, its drawback is that its system of teaching is not based on real-world events. Play money is used to cover made-up expenses and, when the game ends, teaching ceases.

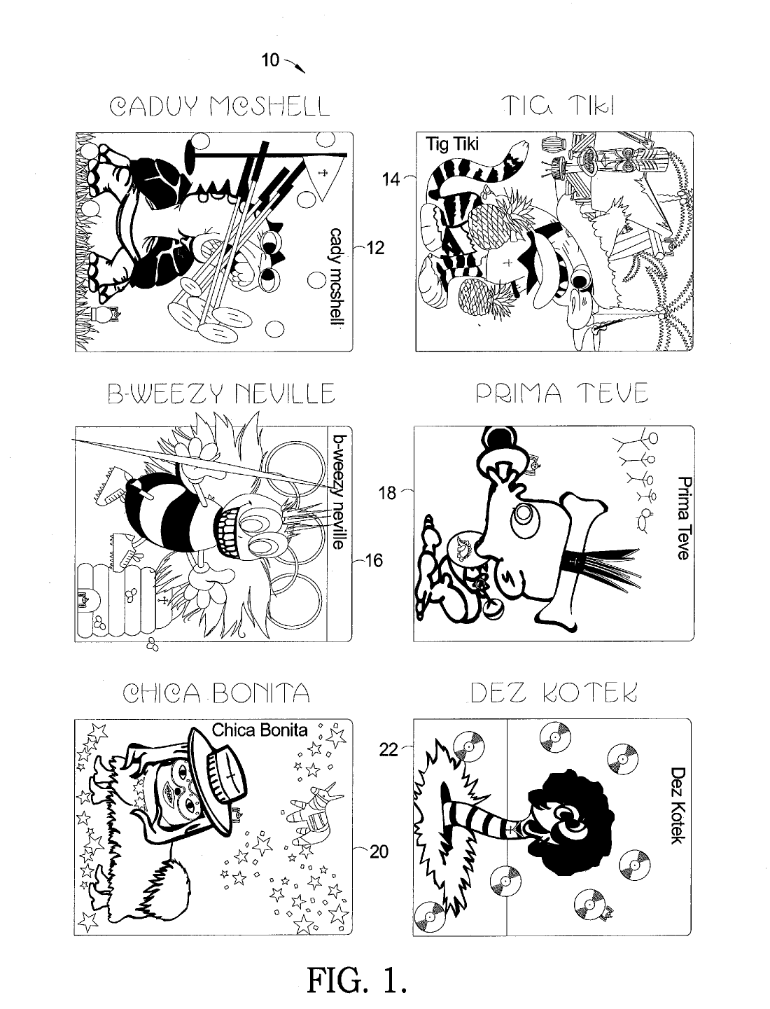

Central to the apparatus and method of teaching the fundamentals of finance to a child, in accordance with the invention, are the currency cards shown in FIG. 1. To maintain the child's interest, a set of currency cards 10 is made available. Each card includes one of a multiple of colorful characters designed to amuse the young child and to hold the child's interest in retaining, as opposed to parting with, the cards. As such, each child may develop a special interest in one or more of the depicted characters and therefore may develop an extra incentive for saving cards depicting those characters. By way of examples, such characters as Caddy McShell 12, Tig Tiki 14, B-Weezy Neville 16, Prima Teve 18, Chica Bonita 20 and Dez Kotek 22 may be printed on one side of each card.

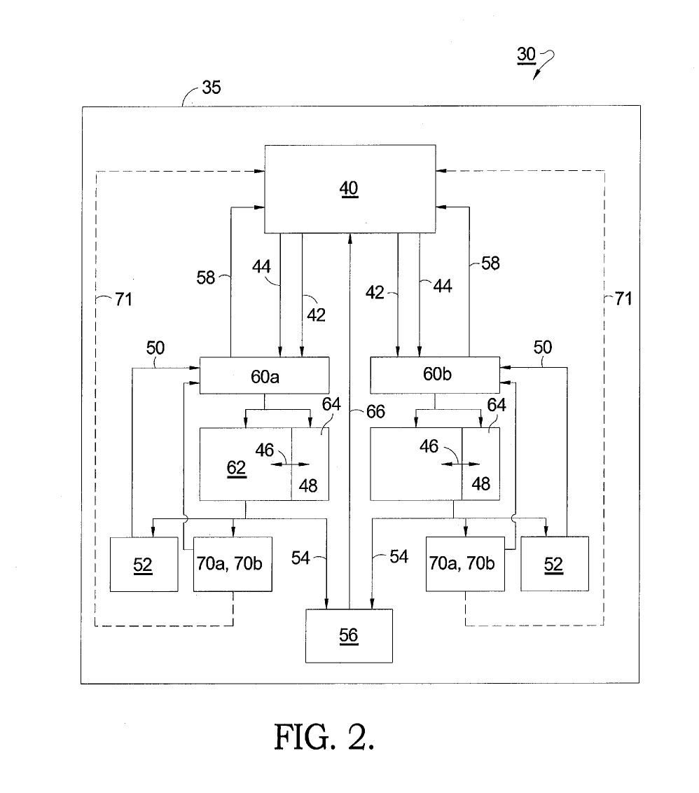

A method 30 of teaching the fundamentals of finance to a young child using currency cards 10 is shown schematically in FIG. 2. In the example shown, a parent or teacher, referred herein as a central reserve 40, oversees the method and parameters of teaching and establishes the entire bounds of the economic system used to teach the fundamentals. Unlike the allowance-reward system used in the prior art that is based on our society's open market economic system, the economic system established by central reserve 40, in accordance with the invention, is a closed system fully contained within box 35 and under full control of the parent or teacher.

Further in accordance with the invention, child/student 60a,b interact with central reserve 40 to establish the economic parameters of the closed system. While FIG. 2 depicts two children/students 60a,b, it is understood that participation by more or less than two is also contemplated by the invention. For simplicity, further discussion of the invention herein, unless otherwise noted, will be in reference to only child/student 60a.

To establish the economic parameters of the closed system, central reserve 40 sets the basic expected behavioral standards 42 that must be met by child/student 60a, and the number 44 of currency cards 10 that will be provided to child/student 60a if the expected behavioral standards are met. Examples of expected behavioral standards 42 that can be set by central reserve 40 may be sleeping through the night, eating vegetables or using manners in a classroom. Central reserve 40 will also establish other parameters such as, for example, the frequency in which currency cards will be allotted on a scheduled basis to child/student 60a. Other parameters, to be discussed in more detail below, will be established by central reserve 40 such as interest rates 46 paid on savings 48, return rates 50 on secured investments 52 and amounts 54 that must be paid by child/student 60a as fixed expenses 56 such as, for example, contributions to charity, taxes, and the like.

As child/student 60a becomes desirous of a reward item or privilege, such as for example, a toy or playing a video game, a request is made to central reserve 40. In response to each request 58 made by child/student 60a for items and privileges for purchase, central reserve may either approve or not approve each request. For each request approved, central reserve 40 may also set the purchase cost for the item or privilege in terms of number of currency cards. As an added teaching benefit, central reserve 40 may permit child/student 60a to negotiate an acceptable purchase price other than the amount initially proposed by central reserve. For a privilege 70a requested, child/student 60a will pay 71 to central reserve 40, in currency cards 10, the purchase price for the privilege being paid immediately before the privilege is bestowed on child/student 60a. For an item 70b requested, central reserve will purchase the item on the open market after child/student 60a pays 71 to central reserve 40, in currency cards, the purchase price for the item.

As currency cards 10 are earned by child/student 60a, or are allotted to child/student 60a on a scheduled basis by central reserve 40, child/student 60a places cards 10 into his or her bank 62. Bank 62 may be any container, such as a box, that may be suitable for safe keeping of cards 10. In one aspect of the invention, cards 10 bearing characters 12-22 may be provided to child/student 60a on a random basis by central reserve 40 to allow the student/child to selectively assign intrinsic value to certain characters to encourage savings. To further encourage savings (and to discourage spontaneous or frivolous spending), a savings account portion 64 may be established as part of bank 62. With regard to savings account portion 64, central reserve establishes a fixed interest rate 46 and a fixed period for paying interest on the number of currency cards kept in bank 62. For example, central reserve 40 may set a savings interest rate of 10% payable every Friday. If earned currency cards or allotted currency cards for the preceding week are paid to child/student 60a and placed in bank 62 on each Saturday, then on the next Friday, central reserve will count the number of currency cards remaining in bank/savings 62/64 and increase the number of remaining cards by an additional 10%. As a further example, say child/student has fifteen currency cards in bank/savings 62/64 just before an additional six allotted/earned currency cards are paid to the child/student on Saturday. During the succeeding week, child/student had spent three currency cards for privileges or items 70a,b purchased leaving eighteen currency cards in bank/savings 62/64 on the following Friday. When central reserve 40 pays to child/student 60a the allotted/earned cards for the past week, child/student 60a will be paid an additional 2 currency cards (10% of 18) as interest on the eighteen currency cards saved and not spent.

In another aspect of the invention, child/student may be taught the benefits of long term investing. Secured investments 52 may be kept in a container, such as a box, suitable for safe keeping of the currency cards 10 that are earmarked by child/student for investing. The container or box containing secured investments are kept by central reserve 40. In this aspect of the invention, central reserve 40 also sets the rate of return 50 and the term in which the investments must remain invested. During the term, child/student 60a will have no access to the held currency cards 10 and, therefore, cannot spend the currency cards on privileges or items desired or cannot enjoy handling the cards or viewing the characters. At the end of the term, central reserve 40 will pay to child/student 60a and to bank 62 an amount of currency cards equal to the rate of return 50. At that point, child/student has the option of leaving all or a portion of the principal in secured investment 52, or moving it entirely to bank 62 for making purchases 70a,70b or for keeping in savings account 48 at the fixed interest rate 46. By way of example, central reserve 40 may set a rate of return of investment at 20% payable after 30 days. Say child/student decides to place twenty currency cards into secured investment 52 and therefore surrenders the twenty cards to central reserve 40 to be placed in a box or container held by central reserve 40. At the end of the thirty day term, central reserve 40 deposits into bank 62 four currency cards (20% of twenty) and gives to child/student 60a the option of leaving all or a portion of the twenty currency cards in secured investments 52 for another term, or to withdraw the twenty cards for transfer to bank 62. Child/student 60a may be provided a further option of returning the four currency cards earned to secured investments 52 for additional earned interest at the end of the new term.

In another aspect of the invention, child/student 60a may be taught the need for providing for fixed expenses. Fixed expenses may be expressed to the child/student as being equivalent to paying taxes or for giving to charity or worship at a fixed rate based on income. In this aspect of the invention, central reserve sets the percentage 54 of income that must be paid as fixed expenses 56. Once the rate is set, child/student 60a will be required to pay in currency cards an amount 66 related to the amount earned and/or allotted from the previous week. Preferably, payment made for fixed expenses will not be made at the same time the earned and/or allotted amount is paid to the child/student by central reserve 40 so as to disassociate the recipient of the fixed expense payment from central reserve 40 (of course, the currency cards made in payment for fixed expense will by placed back into central reserve's kitty for re-distribution). By way of example, central reserve 40 may set a percentage of income 54 that must be paid as fixed expenses as 5%. Say child/student receives twenty currency cards in earned and/or allotted payment on Saturday for the previous week. On a succeeding day, for example Sunday, child/student 60a is required to surrender one currency card (5% of twenty) in payment for fixed expenses.

As an added feature of the invention, whenever currency cards 10 are received by student/child 60a, the currency cards may be drawn blind by the student/child so that the selection of characters 12-22 is random.

While the apparatus and method disclosed herein, in accordance with the invention, were presented with respect to one child/student 60a, it is understood that the invention contemplates its use with any number of children/students including a second child/student 60b as shown in FIG. 2.

What is claimed is:

1. A method of teaching aspects of finances including the steps of:
a) providing a set of currency cards;
b) establishing a central reserve for allocation of said currency cards and for setting economic parameters defining a closed economic system;
c) controllably allocating said currency cards under the set economic parameters; and
d) permitting participation in said closed economic system under the set economic parameters.

2. The method in accordance with claim 1 wherein said permitted participation is by a child.

3. The method in accordance with claim 2 wherein said child is in an age group of between 2 and 12.

4. The method in accordance with claim 2 wherein said method of teaching is taught by a parent of said child.

5. The method in accordance with claim 4 wherein said at least one of said establishing, allocating and permitting steps are performed by the parent.

6. The method in accordance with claim 1 wherein each card of said set of currency cards includes indicia for identification.

7. The method in accordance with claim 6 wherein said indicia of one card differs from the indicia of at least one other card of said set of currency cards.

8. The method in accordance with claim 6 wherein said indicia depicts a colorful character.

9. The method in accordance with claim 1 wherein said economic parameters include at least one of setting the number of currency cards to be allocated, setting the frequency of card allocation, setting an interest rate paid on saved currency cards, setting a rate of return on invested currency cards and setting at rate of taxation paid on the currency cards allocated.

10. The method in accordance with claim 9 wherein the rate of taxation is based on a percentage of the number of currency cards allocated.

11. The method in accordance with claim 9 wherein said permitted participation includes requesting rewards or privileges to be purchased by said currency cards.

12. The method in accordance with claim 11 wherein said central reserve sets.

13. The method in accordance with claim 11 wherein said permitted participation includes negotiating with said central reserve to set the number of currency cards required to purchase said rewards or privileges.

14. A kit for teaching aspects of finances to a child comprising:
a) a plurality of currency cards, each card of said plurality of currency cards including an indicia for identification wherein said indicia of one card differs from the indicia of at least one other card of said plurality of currency cards; and
b) instructions for said teaching using said plurality of currency cards, said instructions including a description of a central reserve and a listing of economic parameters that may be set by the central reserve when teaching said aspects of finances.

15. The kit in accordance with claim 14 wherein said listing of economic parameters includes at least one of:
a) an amount of currency cards to be allocated,
b) an interest rate paid on saved currency cards,
c) a rate of return on invested currency cards, and
d) a rate of taxation paid on the currency cards allocated.
